(19) United States
(12) Patent Application Publication
(10) Pub. No.: US 2011/0059635 A1
(43) Pub. Date: Mar. 10, 2011

(54) Electronic socket with an adjustable floating load

(75) Inventor: Roger Weiss, Foxboro, MA (US)

(73) Assignee: Paricon Technologies, Inc., Fall River, MA (US)

(21) Appl. No.: 12/807,494

(22) Filed: Sep. 7, 2010

Related U.S. Application Data
(60) Provisional application No. 61/276,094, filed on Sep. 8, 2009.

(51) Int. Cl. H01R 4/58; H01R 4/28; H01R 3/00

(52) U.S. Cl. 439/86; 439/775; 439/488

(57) ABSTRACT

Floating clamp sockets useful in electronic interconnection applications are disclosed.

This application claims benefit of U.S. Provisional Application No. 61/276,094 filed Sep. 8, 2009, which is incorporated by reference herein in its entirety.

### BACKGROUND

This disclosure relates to floating clamp sockets useful in electronic interconnection applications.

Surface mount electronic sockets typically incorporate contacts that are spring members. The lid of the socket can be closed to a fixed location and the contact load applied by compression of the contact spring. The variation in dimensional tolerance of the device and the socket can be compensated for by using a contact spring system having an appropriate length. These sockets have the disadvantage that the long contact length results in interconnects with inadequate electrical capability for devices operating at electrical frequencies above ca. 2 GHz. As socket interconnects are designed to incorporated shorter electrical contacts to accommodate high frequencies, the ability to deal with the system mechanical tolerances becomes more challenging. Current solutions can result in reduced electrical performance and contact damage caused by over-compression.

Replacing the fixed displacement clamp system with a floating spring clamp allows the clamp to become a controllable load system. The use of a spring clamp and a floating clamping member has the following advantages. A spring clamp system allows the electrical contact to be very short and without a conventional spring member. This enables very low loss contacts capable of operating at very high frequencies. The use of a floating clamp further compensates for all device mechanical tolerances except for the planarity of the device contact array. The planarity of the contact array may be addressed by the contact structure.

### SUMMARY

In a first aspect, an electronic socket comprising a mechanism for applying an adjustable floating load to an electronic interconnect is disclosed.

In a second aspect, an electronic interconnect assembly is disclosed comprising: a backing plate; a first electronic device adjacent the backing plate; a compression interconnection element adjacent the first electronic device; a second electronic device adjacent the compression interconnection element; a drive plate adjacent the second electronic device; a clamping plate disposed apart from the drive plate, wherein the clamping plate is fixedly secured to the backing plate; a knob comprising a bore and a threaded portion, wherein the threaded portion is threaded into the clamping plate; and a floating load cartridge disposed within the bore; wherein turning the knob causes the floating load cartridge to contact the drive plate to apply a load thereby causing the compression interconnection element to electrically interconnect the first electronic device and the second electronic device.

### BRIEF DESCRIPTION OF THE DRAWINGS

Those skilled in the art will understand that the drawings, described herein, are for illustration purposes only. The drawings are not intended to limit the scope of the present disclosure.

FIG. 1 shows examples of spring contacts in extended (1A) and compressed (1B) configurations.

FIG. 2 shows an electronic socket employing spring contacts to electrically connect a device to electrical contacts on a printed circuit board.

FIG. 3 shows an example of a floating clamp socket.

FIG. 4 shows examples of a floating load cartridge (4A) and a knob (4B).

FIG. 5 shows an example of an electronic socket incorporating a floating load clamp before the load is applied to the electronic interconnect.

FIG. 6 shows an example of an electronic socket incorporating a floating load clamp while increasing load is applied to the electronic interconnect.

FIG. 7 shows an example of an electronic socket incorporating a floating load clamp when a desired load is applied to the electronic interconnect.

FIG. 8 shows an example of a calibration curve correlating the number of knob turns to the applied load.

FIG. 9 shows a perspective view schematic of a floating clamp socket.

FIG. 10 shows a perspective cross-sectional view of a floating clamp socket.

FIG. 11 shows a side view of a floating clamp socket.

FIG. 12 shows a top view of a floating clamp socket.

### DETAILED DESCRIPTION

The use of a spring clamp adds the additional socket design variable that the applied load can vary with the device thickness and other mechanical characteristics. The socket systems disclosed herein accomplish this by incorporating a floating load clamp and a load indicator into the socket clamp, which provides a measure of the compressive load applied to the electronic interconnect.

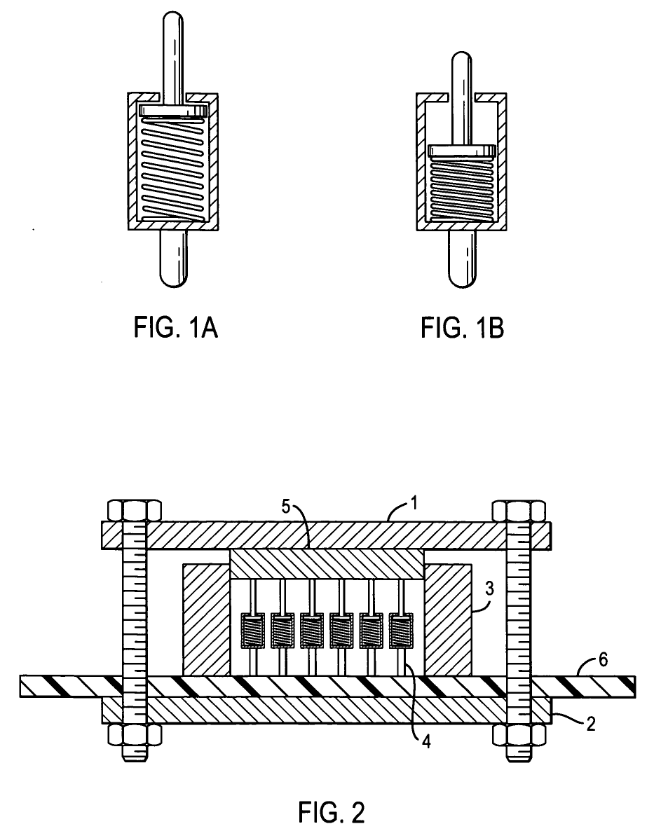

FIG. 1 shows the construction of one type of spring contact that is provided by many vendors. This contact is typically referred to as a spring pin or pogo pin. FIG. 2 illustrates the operation of a spring contact in a typical electronic socket. When clamping plate 1 is closed toward backing plate 2 to a fixed position as established by, for example, stand-off 3, the springs of the pogo pins 4 compress by an appropriate distance to physically contact and electrically interconnect electrical contacts on device 5 to electrical contacts on device 6. Variations in device thickness, wedge and solder ball height, socket tolerances, and other dimensional variations must all be compensated for by the springs. This requires a spring contact of a length that can compromise high frequency electrical performance.

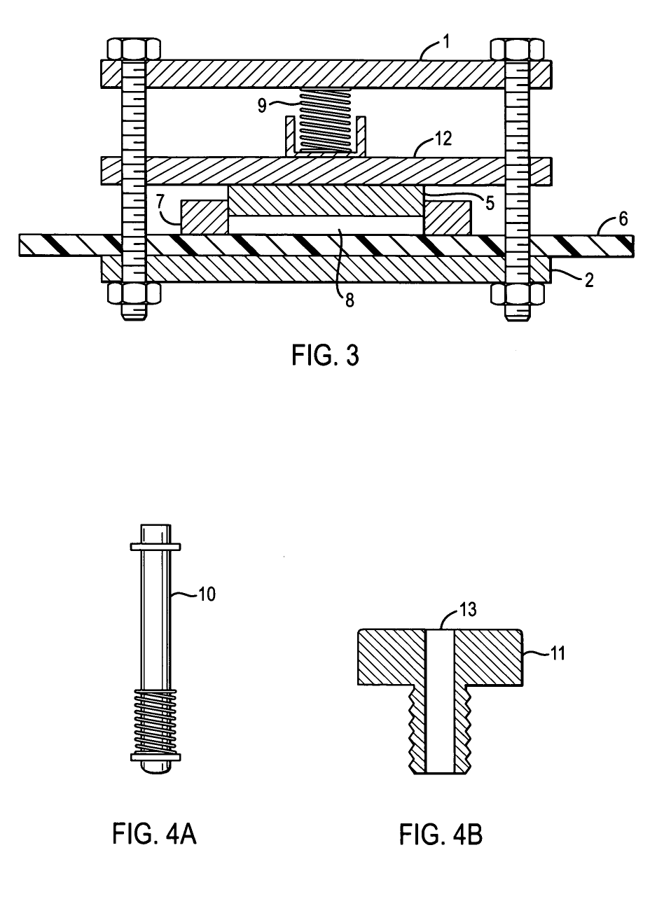

To accommodate the combined mechanical tolerances and allow for shorter electrical contact length, a fixed deflection clamping system as shown in FIG. 2 can be replaced by a floating clamp system as shown in FIG. 3. The floating clamp system shown in FIG. 3 includes a clamping plate 1, a backing plate 2, and a compression plate 12. Compression plate 12 is coupled to clamping plate 1 by a compression spring 9. Compression plate 12 is floating in the sense that it can freely orient to evenly distribute the load applied by clamping plate 1 and backing plate 2. The floating load applied by compression plate 12 is transferred to device 5 and device 6 causing compressible interconnection material 8 to electrically interconnect opposing electrical contacts on the lower surface of device 5 with electrical contacts on the upper surface of device 6. Because the compression member is floating on a spring and therefore can conform to the top surface of the device, a uniform load can be applied and the device and socket height tolerances can be accommodated. The only remaining tolerance that is not controlled by the floating clamp socket is the planarity of the electrical contact surfaces.

Although a compression spring is shown in FIG. 3, any other elastic element may be used to transfer the load to compression plate 12. It is desirable that the elastic element be capable of maintaining the applied load during the intended useful life of the product. For example, in device testing applications the time of use may be few minutes, and in embedded system applications the time of use may be several years or longer. In such applications it is important that the load applied to the system provide electrical interconnections between the devices that meet the electrical performance requirements of the system and that are reliable during the time of intended use. Generally, the elastic element adheres to Hooke's law in which deflection is proportional to the load. Examples of useful elastic elements include compressible polymers and mechanical springs. Mechanical springs may be flat springs, leaf springs, or compression springs including open coiled, helical springs, Belleville springs, volute springs, cantilever or simple beam springs, and tapered, conical, barrel, hourglass, or variable pitch springs. In certain embodiments, an elastic element exhibits a spring constant from about 2 N/m to about 300,000 N/m, from about 3 N/m to about 250,000 N/m, from about 4 N/m to about 125,000 N/m, and in certain embodiments, from about 10 N/m to about 50,000 N/m. In certain embodiments, an elastic element exhibits a spring constant from about 5 N/m to about 250,000 N/m, and in certain embodiments, from about 5 N/m to about 62,500 N/m. In certain embodiments, an elastic element exhibits any of the foregoing spring constants at a deflection from about 1 mm to about 10 mm, from about 2 mm to about 8 mm, or from about 3 mm to about 6 mm. In certain embodiments, an elastic element will exhibit a spring constant of 5 N/m and a deflection of 4 mm.

Devices to be interconnected may be any electronic device such as silicon wafers, printed circuit boards, flexible substrates, electronic packages, etc. Electrical contacts on the devices can be area arrays or land grid arrays. In certain embodiments, a land grid array packages in interconnected to a land grid array on a printed circuit board.

The compressible interconnection material, when compressed, provides for electrical conductivity through the thickness of the material and is electrically resistive for greater than a certain dimension in the plane of the material. The appropriate interconnection material for a particular application is determined in part by the pitch area of the electrical contact pads on the devices. Many compressible interconnection materials are known in the art. Compressible interconnection materials are typically provided as sheets comprising elastomeric material in which electrical conductive elements are embedded. Sheet thicknesses may be, for example from about 1 mils to about 200 mils, from about 5 mils to about 100 mils, from about 5 mils to about 50 mils, and in certain embodiments, from about 5 mils to about 20 mils. The elastomeric material may be solid or foamed and may comprise silicon. Conductive elements may be randomly dispersed or oriented perpendicular to the plane of the sheet. In certain embodiments, the compressible interconnection material is an anisotropically conductive interconnection material comprising columns of conductive particles oriented perpendicular to the plane of the sheet. Certain examples of conductive elastomeric interconnection materials are described by Corbin et al., IBM J Res Dev 2002, 46(6), 763-778. Weiss et al. disclose conductive elastomeric interconnection materials comprising chains of conductive particles aligned perpendicular the plane of an elastomer sheet. Weiss et al., U.S. Pat. Nos. 6,854,985, 6,854,986, 6,447,308, 6,649,115, and 6,497,583; and U.S. Application Publication No. 2003/0224633, each of which is incorporated by reference herein in its entirety. The conductive elastomers disclosed by Weiss et al. are a composite of conductive metal elements in an elastomeric matrix that conducts through the thickness. This form of conductive elastomer comprises a large number of closely spaced columns of electrically conductive particles spanning the sheet thickness. When compressed between opposing conductors, such as pads, a separable, compliant high performance interconnect is formed. For thicknesses of about 0.002 inches to about 0.020 inches, the conductive elastomers disclosed by Weiss et al. are capable of forming high performance separable interconnects characterized by an inductance of less than 1 nH and a 3 dB fifth harmonic at greater than about 40 GHz. Thus, in certain embodiments where a high performance microelectronic assembly is to be interconnected to a high performance network interface, the conductive elastomers disclosed by Weiss et al. can be advantageously employed. The choice of an appropriate elastomeric interconnection technology used in an electronic interconnection or system provided by the present disclosure can depend on a number of factors including the high performance requirements of the system, power requirements, thermal requirements, and environmental requirements. However, at least because of the short interconnection length, which can be less than 100 mils and in certain embodiments, less than 20 mils, the electrical performance of such interconnects can be superior to that of spring contacts.

The introduction of the spring clamp system solves several problems associated with previous compression-type socket designs. It also introduces the variable element that the applied load of the spring can vary due to socket and device height tolerance variation. This element is addressed by certain embodiments of the present disclosure.

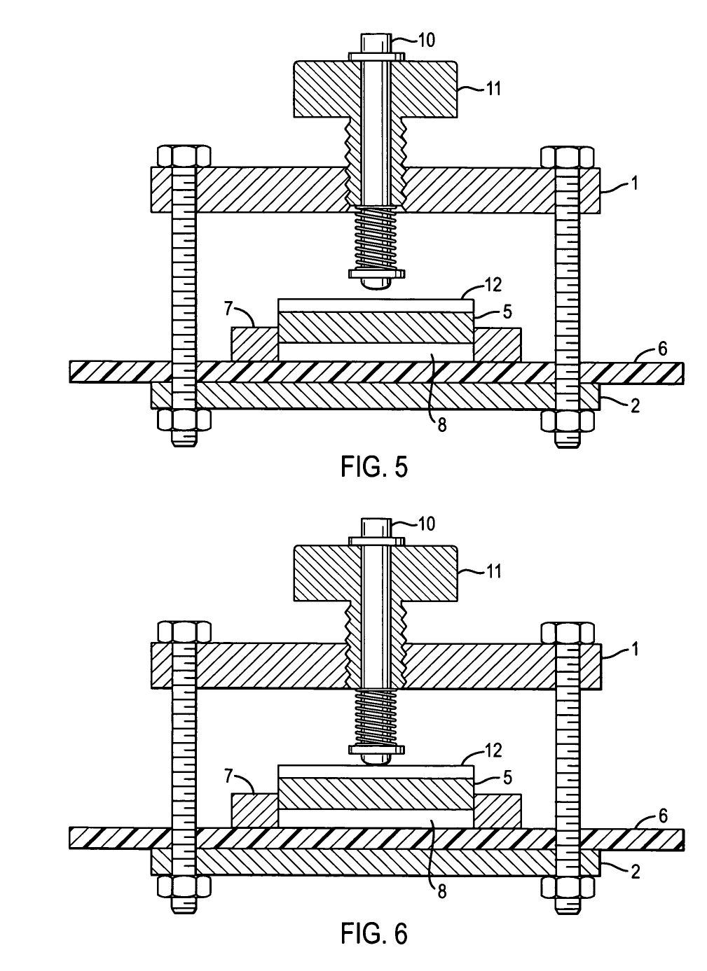

FIGS. 4A and 4B shows two additional elements that may be incorporated into the socket clamp structure: a floating load cartridge 10 and a threaded knob 11 that incorporates an open center bore 13 to house load cartridge 10. FIGS. 5-7 show how these elements can be integrated into the socket design. In these figures, threaded knob 11 is screwed into corresponding threads in clamping plate 1 and load cartridge 10 is located within bore 13 and positioned above drive plate 12. As shown in FIG. 5, initially load cartridge 10 is not in contact with drive plate 12 and no load is applied to device 5, interconnection material 8, and device 6. In this case element 7 is shown as a frame retaining interconnection material 8 and device 5, and which can serve to align the electrical contact areas on device 5 with those on device 6. As knob 11 is turned, e.g., screwed into clamping plate 1, load cartridge 10 makes contact with drive plate 12 as shown in FIG. 6. As knob 11 is further rotated, load is applied to the devices and interconnection material to electrically interconnect device 5 and device 6.

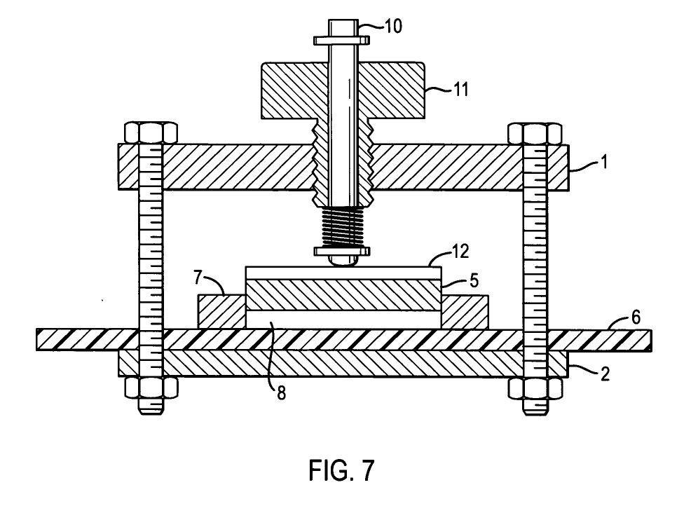

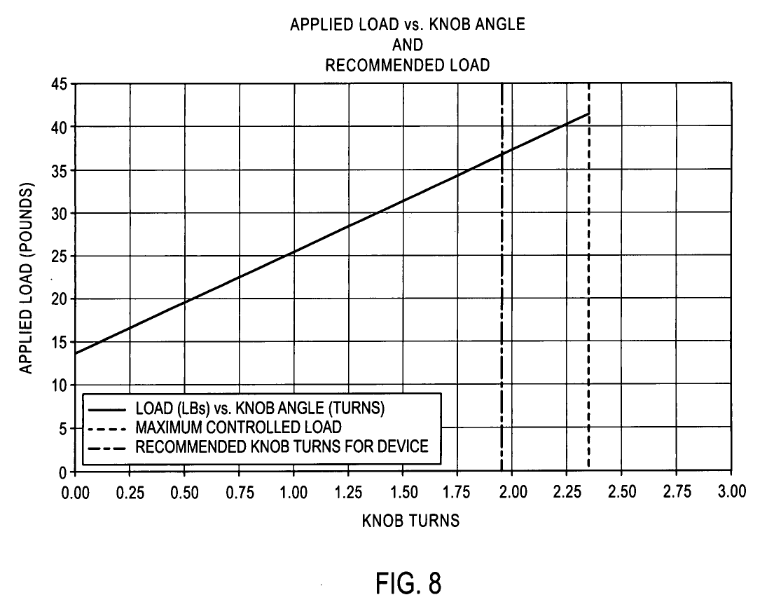

There are at least two factors that can indicate when all mechanical tolerances have been accommodated: (1) the torque required to turn knob 11 increases; and (2) the top of load cartridge 10 begins to move upwards with respect to the top of knob 11. With continued tightening of knob 11, load cartridge 10 extends further above the surface knob 11 until a desired load has been applied, for example as shown in FIG. 7. The extent to which the top of load cartridge 10 extends above the top of knob 11 is equivalent to the compression of the spring incorporated into load cartridge 10 which in turn is proportional to the compressive load applied to the interconnects. Hence, the applied load (F) is given by the simple linear equation F=k·x+F0 where k is the spring constant for spring 9, x is the distance that load cartridge 10 has moved with respect to knob 11 and F0 is any preload that may be applied to spring during assembly. In certain embodiments, the preload may be from about 0% to about 50%, and in certain embodiments, from about 10% to about 25% of the length of the spring. Although this distance can be directly measured in a number of ways, the knob itself can provide a very accurate means of measuring the applied load. For example, when load cartridge 10 first contacts load plate 12, the angular position of knob 11 can be noted as the load, e.g., zero (0), at first contact. As knob 11 is tightened from the point of contact, the angular position of the knob can also be a direct and accurate measure of the applied load. Using a calibration curve such as shown in FIG. 8 it is possible to correlate the applied load as a function of the knob position. The load can also be measured as the distance the top of the load cartridge extends above the upper surface of clamping plate 1, using a calibration curve correlating the applied load with the distance. Alternatively, a load cell may be incorporated into the system.

In certain embodiments, floating claim sockets provided by the present disclosure apply a load from about 0.005 N to about 1,000 N, from about 0.01 N to about 750 N, from about 0.015 N to about 500 N, from about 0.02 N to about 250 N, from about 0.05 N to about 200 N, from about 0.1 N to about 100 N, and in certain embodiments, from about 1 N to about 50 N. In certain embodiments, floating claim sockets provided by the present disclosure apply a load from about 0.02 N to about 250 N.

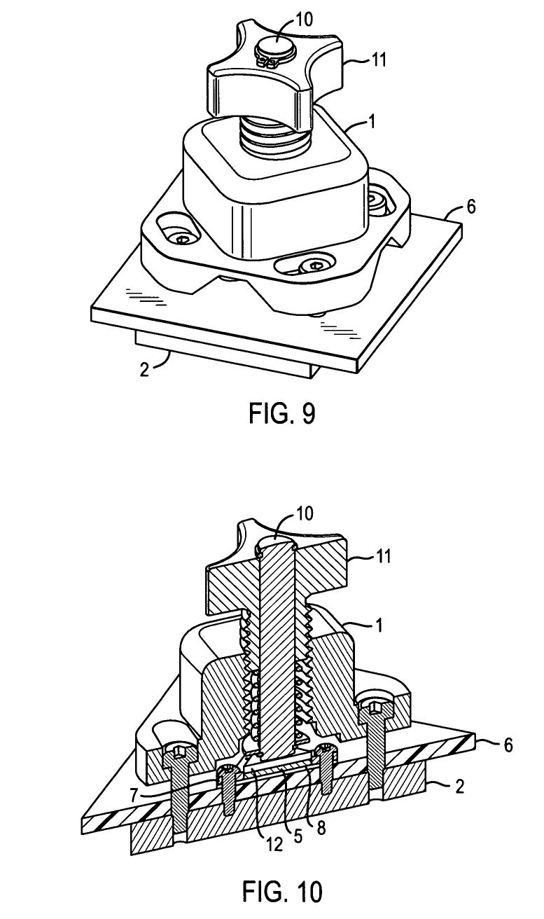

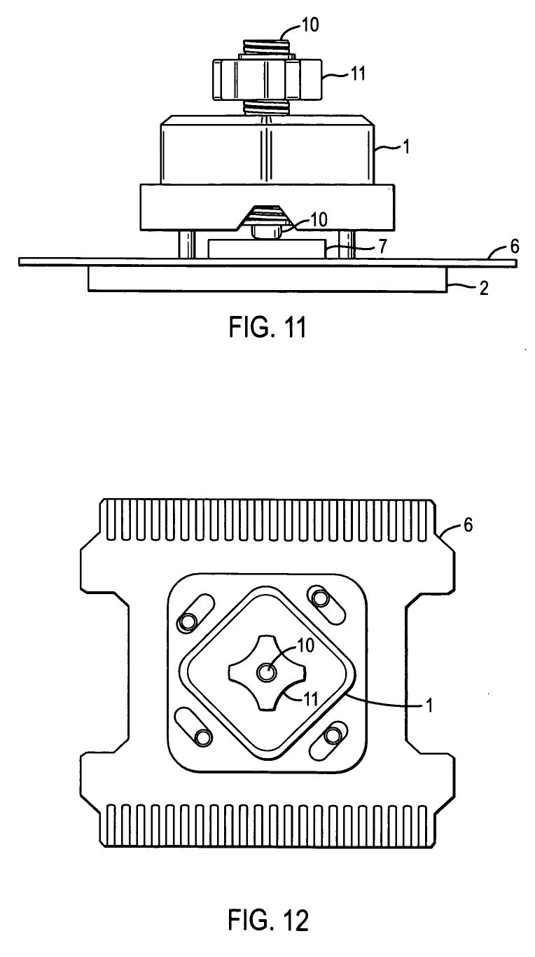

Floating clamp sockets provided by the present disclosure are intended to be sufficiently mechanically robust so as to provide the load to the electrically interconnect and to maintain that load during for an appropriate time as determined by the application. For example, the socket must not mechanically fatigue under the applied load and under the environmental conditions of use. To accomplish these objectives, many mechanical systems can be envisaged and any appropriate material can be used. For example, an alternative socket design is shown in FIGS. 9-12. In this embodiment, clamping plate 1 has a bulk. FIG. 9 and FIG. 10 show perspective views of certain embodiments of floating clamp sockets provided by the present disclosure. FIG. 11 and FIG. 12 show side and top views, respectively, of the floating clamp socket shown in FIGS. 9 and 10. Furthermore, components of the socket such as the clamping plate, the compression plate, and the backing plate may be made from any appropriate material such as stainless steel, aluminum, or a structural plastic.

Although it can be desirable that the load applied to the interconnect not vary appreciably during use, in the event that the applied load changes as determined by changes in the angular position of the knob or the vertical extension of the load cartridge with respect to the backing plate, the load can re-adjusted during use. Furthermore, a compressible interconnection material typically has a range of compression over which effective and reliable electrically interconnects are formed. Thus, some change in the applied load during operation may be acceptable.

Finally, it should be noted that there are alternative ways of implementing the embodiments disclosed herein. Accordingly, the present embodiments are to be considered as illustrative and not restrictive, and the claims are not to be limited to the details given herein, but may be modified within the scope and equivalents thereof.

What is claimed is:

1. An electronic socket comprising a mechanism for applying an adjustable floating load to an electronic interconnect.

2. The electronic socket of claim 1, wherein the mechanism comprises a compression element.

3. The electronic socket of claim 2, wherein the compression element comprises a compression spring.

4. The electronic socket of claim 3, wherein the compression spring has a spring constant from about 5 N/m to about 125,000 N/m.

5. The electronic socket of claim 1, wherein the load is from about 0.02 N to about 250 N.

6. The electronic socket of claim 1, comprising a load indicator.

7. The electronic socket of claim 6, wherein the load indicator comprises a load cell.

8. The electronic socket of claim 6, wherein the load indicator comprises a linear measure.

9. The electronic socket of claim 6, wherein the load indicator comprises an angular measure.

10. The electronic socket of claim 1, wherein the electronic interconnect comprises an elastomeric interconnection material.

11. An electronic interconnection assembly comprising:
a backing plate;
a first electronic device adjacent the backing plate;
a compression interconnection element adjacent the first electronic device;
a second electronic device adjacent the compression interconnection element;
a drive plate adjacent the second electronic device;
a clamping plate disposed apart from the drive plate, wherein the clamping plate is fixedly secured to the backing plate;
a knob comprising a bore and a threaded portion, wherein the threaded portion is threaded into the clamping plate; and
a floating load cartridge disposed within the bore;
wherein turning the knob causes the floating load cartridge to contact the drive plate to apply a load thereby causing the compression interconnection element to electrically interconnect the first electronic device and the second electronic device.

12. The electronic interconnection assembly of claim 11, wherein the load cartridge comprises a compression element.

13. The electronic interconnection assembly of claim 12, wherein the compression element comprises a compression spring.

14. The electronic interconnection assembly of claim 13, wherein the compression spring has a spring constant from about 5 N/m to about 125,000 N/m.

15. The electronic interconnection assembly of claim 11, wherein the load is from about 0.02 N to about 250 N.

16. The electronic connector assembly of claim 11, comprising a load indicator.

17. The electronic interconnection assembly of claim 16, wherein the load indicator comprises a load cell.

18. The electronic interconnection assembly of claim 16, wherein the load indicator comprises a linear measure.

19. The electronic interconnection assembly of claim 16, wherein the load indicator comprises an angular measure.

20. The electronic interconnection assembly of claim 11, wherein the compression interconnection element comprises an elastomeric interconnection material.
